(19) United States
(12) Patent Application Publication
(10) Pub. No.: US 2008/0195582 A1
(43) Pub. Date: Aug. 14, 2008

(54) Context Based Keyword Search

(75) Inventors: Ke Yu, Alpharetta, GA (US); Buddy Yaussy, Duluth, GA (US)

Correspondence Address: THOMAS, KAYDEN, HORSTEMEYER & RISLEY, LLP/;AT&T Delaware Intellectual Property, Inc., 600 GALLERIA PARKWAY, S.E., SUITE 1500, ATLANTA, GA, 30339-5994, US

(73) Assignee: BELLSOUTH INTELLECTUAL PROPERTY CORPORATION, Wilmington, DE (US)

(21) Appl. No.: 11/672,802

(22) Filed: Feb. 8, 2007

(51) Int. Cl. G06F 17/30

(52) U.S. Cl. 707/3; 707/E17.014

(57) ABSTRACT

Embodiment of the present disclosure can also be viewed as providing methods for inputting characters into a user interface. In this regard, one embodiment of such a method, among others, can be broadly summarized by the following: receiving a character string; determining possible keywords corresponding to the character string based upon context in which the character string is input; and providing at least a subset of the possible keywords to allow selection of at least one of the keywords in the at least a subset if a keyword of interest is found. Other methods and systems are also provided.

### TECHNICAL FIELD

The present disclosure is generally related to computing and electronic devices and, more particularly, is related to user interface systems.

### BACKGROUND

Many different types of communication devices can be used to access computer networks, such as the Internet or other communications networks. For example, cell phones and personal digital assistants can be used for web browsing or sending text messages. Also, remote controls to set top boxes can be used to request information via the set top box and television (TV) network (e.g., Internet Protocol TV (IPTV) network). One problem with these user interfaces is that it may be difficult to input strings of information, such as words or phrases, using a small keypad, such as often found on cell phone devices, personal digital assistants, remote controls, or portable electronic devices. Research indicates that one of the reasons users do not take advantage of some device applications, such as text message or search capabilities, is the difficulty involved in entering data. If devices and applications were more user friendly, users may be more likely to take advantage of these device features.

Thus, a heretofore unaddressed need exists in the industry to address the aforementioned deficiencies and inadequacies.

### SUMMARY

Embodiments of the present disclosure provide systems, methods, and computer-readable media for inputting characters into a user interface. One embodiment of the system includes a network server configured to receive a character string and determine possible keywords corresponding to the character string based upon context in which the character string is input.

The system further includes at least one database of context information, where the context information is used by the network server to determine the context, and a network client configured to receive the context information and the possible keywords; determine a subset of the possible keywords that are likely to be of interest after analyzing the context information; and display the subset of keywords

Embodiment of the present disclosure can also be viewed as providing methods for inputting characters into a user interface. In this regard, one embodiment of such a method, among others, can be broadly summarized by the following: receiving a character string; determining possible keywords corresponding to the character string based upon context in which the character string is input; and providing at least a subset of the possible keywords to allow selection of at least one of the keywords in the at least a subset if a keyword of interest is found.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an embodiment of an operating system for a context search system of the present disclosure.

FIG. 2 is a diagram showing a schematic view illustrating exemplary architecture for a computing devices, such as that shown in FIG. 1.

FIG. 3 is a diagram depicting a table of characters associated with respective keypad buttons of one implementation of a triple tap keypad, such as that used in an embodiment of the system of FIG. 1.

FIG. 4 is a diagram depicting keypad buttons referenced in FIG. 3.

FIG. 5 is a diagram showing a schematic view illustrating exemplary architecture for a network server, such as that shown in FIG. 1.

FIGS. 6A-6B are flow chart diagrams illustrating operation of an embodiment of the context search system of FIG. 1.

FIG. 7 is a diagram illustrating one embodiment of a login screen for a network client, such as that shown in FIG. 2.

FIG. 8 is a diagram illustrating an exemplary user interface to a search for a network client, such as that shown in FIG. 2.

FIG. 9 is a diagram depicting relationships between the database retriever of FIG. 5 and network databases.

FIG. 10 is a diagram depicting logic of the network client of FIG. 2.

FIGS. 11-32 are diagrams illustrating exemplary user interfaces to a search engine for a network client, such as that shown in FIG. 2.

FIG. 33 is a flow chart diagram illustrating an embodiment of a method for inputting characters into a user interface in accordance with the present disclosure

### DETAILED DESCRIPTION

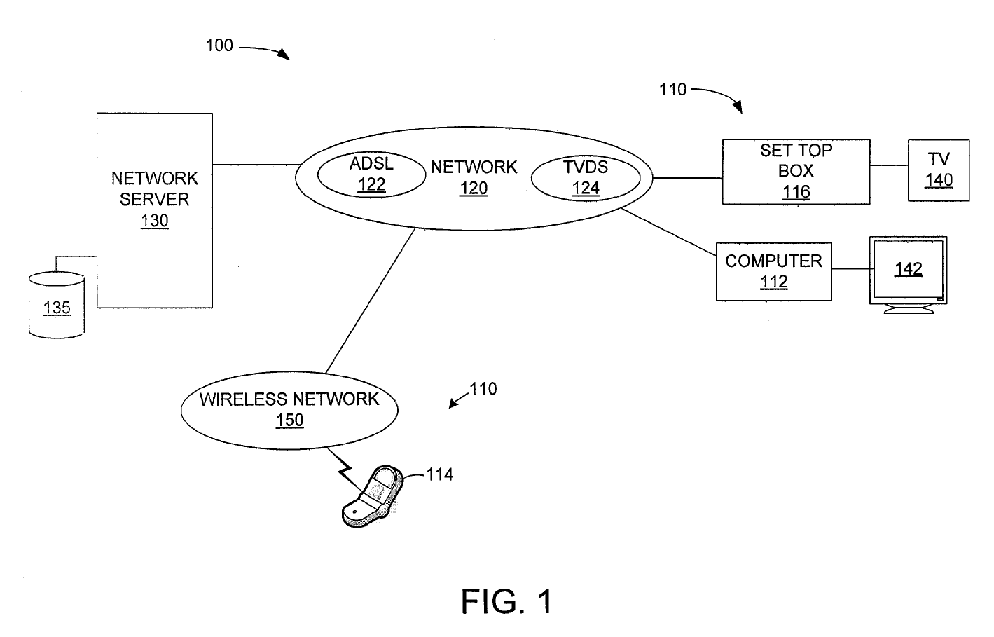

Referring now to the drawings, in which like numerals indicate corresponding parts throughout the several views, FIG. 1 illustrates an example operating environment 100 in which a context search system can be used. As indicated in this figure, the environment 100 can include one or more computing devices 110 that, by way of example, can comprise personal computers (PCs) 112, personal digital assistants, wireless devices, such as a cellular telephone 114, network-enabled portable devices, set top boxes 116, Blackberry®, Ipod®, Treo®, etc. In this way, the present discussion can be applied to any device that can be configured for providing the desired functionality of the computing device 110.

As is further indicated in FIG. 1, each of the computing devices 110 can be connected to a network 120. The network 120 typically comprises one or more sub-networks (e.g., an Asymmetric Digital Subscriber Line (ADSL) system 122, a television distribution system (TVDS) 124) that are communicatively coupled to each other. By way of example, these networks can include one or more local area networks (LANS) and/or wide area networks (WANs). Further, the network 120 may comprise a set of networks that forms part of the Internet. Also shown connected to the network 120 is a network server 130 that operates a search engine and communicates with network databases 135.

One method for transmitting information, such as video, is the digital video broadcasting (DVB) protocol or standard. Alternatively, an increasingly popular method of transmitting digital video is Internet Protocol Television (IPTV) because of the numerous advantages IPTV provides for network providers to offer video services more efficiently in certain cases. For example, IPTV is suited for programs intended for use by only one subscriber, because a minimum amount of the network is tied up to serve that need. Therefore, the number of channels that can be carried to subscribers can be significantly higher when compared to traditional video delivery systems and depending on the transmission capacity of the network and how much of that capacity is devoted to IPTV. Finally, the same data transmission capacity of a network can be used for all other data traffic.

In an embodiment employing IPTV, a server, such as the network server 130, delivers digital television service to users using the Internet Protocol (IP) over a broadband connection through technologies used for the World Wide Web. IP video signals can be received by customer premise equipment as IP multicast streams delivered from the network. To avoid sending all channel signals simultaneously, each video channel can use a specific IP multicast identification, and the customer premise equipment can signal to the network which channel the user is currently viewing or requesting. The signaling information can be carried using Internet Group Management Protocol (IGMP). Therefore, when a user changes the channel, the customer premise equipment can transmit an IGMP “join” message to the network for the new channel, and it can send an IGMP “leave” message for the original channel. The signaling information for the current channel can be transmitted to an IP-enabled set top box, such as the set top box 116, which relays the signal to a television set 140 or to a personal computer, such as the personal computer 112.

One embodiment of the context search system 100 includes the network server 130. The network server 130 is connected to the computing device 110 of a user via the communications network 120. In one embodiment, the network server 130 is network equipment that provides the storage for media program material (e.g., video, web pages, etc.), which can be requested by a user. In a cable communications environment, the network server 130 may comprise a video server that performs many functions, such as admission control, request handling, data retrieval, guaranteed stream transmission, stream encryption, and support of functions such as pause, rewind, and fast forward. In a web environment, the network server 130 may comprise a web server that provides Internet content.

The network 120 connects the network server 130 and the equipment at a customer's premise (e.g., set top device 116, personal computer 112, etc.). In some embodiments, the context search system 100 involves the transfer of large volumes of data at very high speed. Also, in some embodiments, a user may utilize more than one communication network 120 to access the network server 130. For example, a user could connect with the network server 130 utilizing the Internet to watch a movie or listen to music.

According to exemplary embodiments, the ADSL system 122 is an asymmetrical bi-directional transmission system used as the local subscriber loop between the local telephone switch and the subscriber's home, thus allowing the economical transmission of broadband services without signal regenerators. In combination with the telephone signals, which may be analog or digital (ISDN), control (e.g., 16 and 24 kbit/s) and video (e.g., 2 to 6 Mbit/s) information channel may be transmitted downstream towards the user. In the upstream direction there are at least telephone and control channels. In some embodiments, the communication network 120 may utilize the ADSL system 122 to provide Internet-based services to a customer's premises.

The TVDS 124 (e.g., IPTV) is based on a tree-and-branch topology in some embodiments and on a star topology in some others. The audio and video signals are transmitted via coaxial cables in the subscriber line area. The trunk lines are usually made by fiber. Due to the high bandwidth, it has many channels available, which are multiplexed onto the cable using Frequency Division Multiplexing (FDM). Channel transmission on the cable is primarily unidirectional. Signals are inserted on the downstream channels by a head-end.

Signals from user or customer sites are allowed on upstream channels and they are transmitted towards the head-end. Also, there is provision for upstream message transmission. In some embodiments, the communication network 120 may utilize the TVDS 124 to provide Internet-based services to a user's or customer's premises.

A cable head-end is the facility at a cable TV center that originates and communicates cable TV services and cable modem services to subscribers. In distributing cable television services, the head-end includes a satellite dish antenna for receiving incoming programming. When a cable company provides Internet access to subscribers, the head-end includes the computer system and databases needed to provide Internet access.

In one embodiment, a switching office (not shown) includes both the telephone company's central office and the cable company's head-end. The switching office is the place where services are fed and distributed to individual subscribers. According to exemplary embodiments, the switching office contains the head-end, switches, and network servers 130. In the head-end equipment, the video streams are formatted and organized for transmission in the communication network. If the ADSL 122 is used, the switching office switches the video streams onto the subscriber loops with telephone calls.

A user interacts with the services by a client device, such as the computing device 110. In one embodiment, for the set top box or unit 116, information is displayed to a user using the television display 140, while in the case of a computer 112, information is displayed to a user using a computer monitor 142. A user may be connected to the network server 130 and browse through a selection of content or services. In one embodiment, the connection is over a cable television network. In another embodiment, the connection is over the Internet. Other embodiments may employ different mediums, such as wireless networks 150.

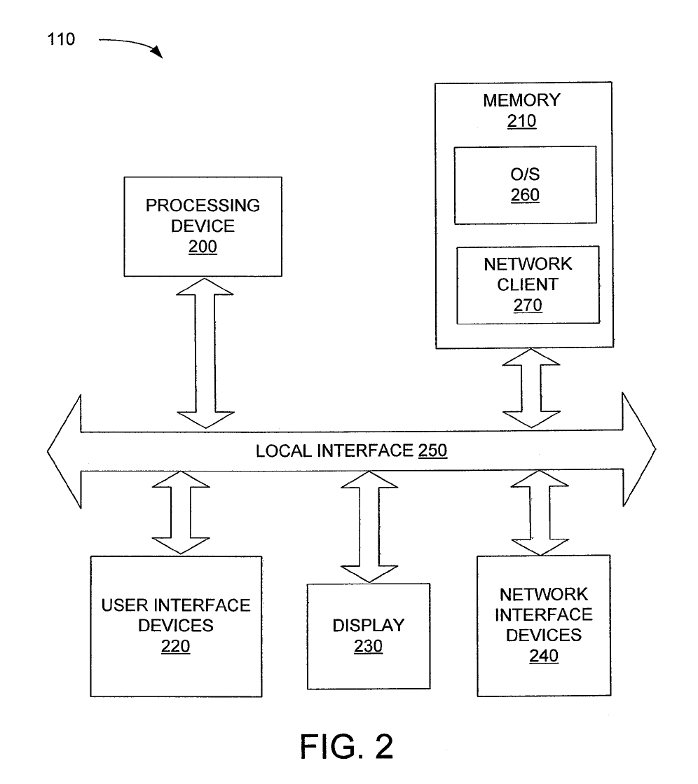

FIG. 2 is a schematic view illustrating exemplary architecture for the computing devices 110. As indicated in FIG. 2, each computing device 110 can comprise a processing device 200, memory 210, one or more user interface devices 220, a display 230, one or more network interface devices 240, and a local interface 250 to which each of the other components electrically connects. The local interface 250 may have additional elements, which are omitted for simplicity, such as controllers, buffers (caches), drivers, repeaters, and receivers to enable communications. Furthermore, the local interface 250 may include address, control, and/or data connections to enable appropriate communications among the aforementioned components.

The processing device 200 can include any custom made or commercially available processor, a central processing unit (CPU) or an auxiliary processor among several processors associated with the computing device 110, a semiconductor based microprocessor (in the form of a microchip), or a macroprocessor. The memory 210 can include any one of a combination of volatile memory elements (e.g., random access memory (RAM, such as DRAM, SRAM, etc.)) and nonvolatile memory elements (e.g., ROM, hard drive, tape, CDROM, etc.).

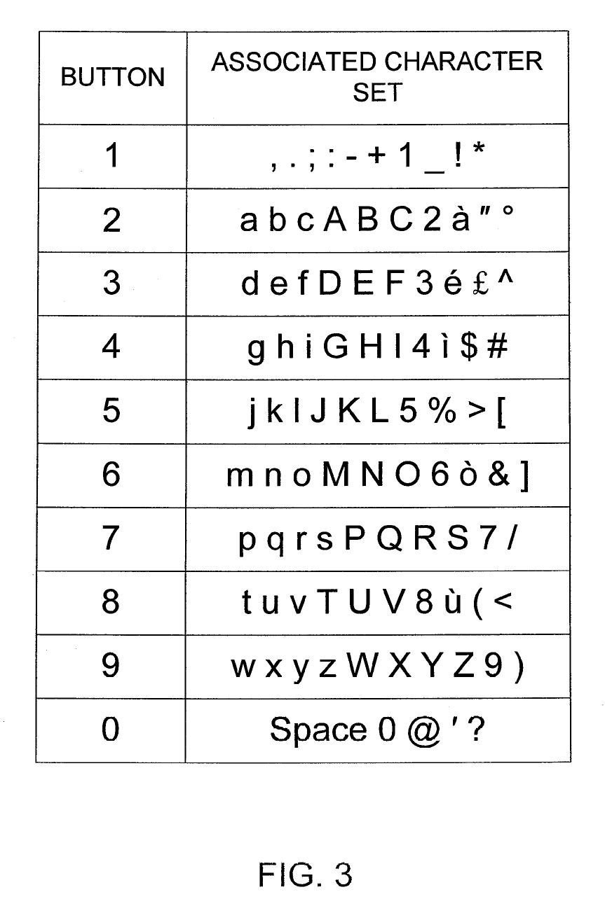

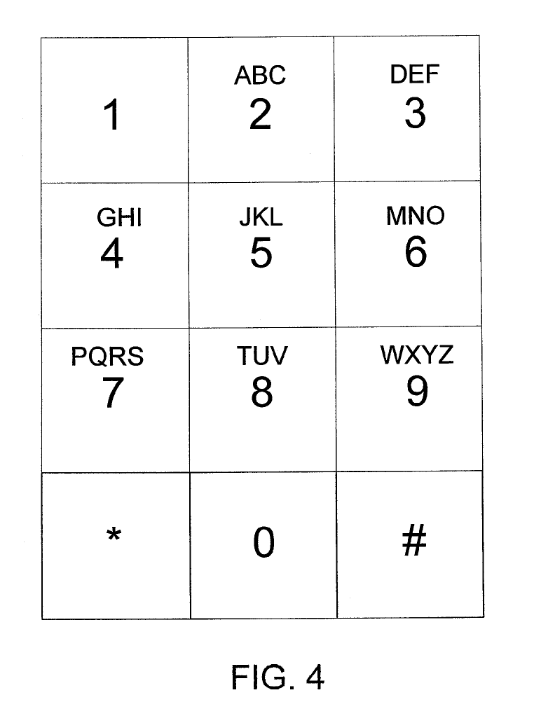

In one embodiment, the user interface devices 220 may comprise those normally used in conjunction with a general purpose computer 112. For instance, the user interface devices 220 may comprise a keyboard and mouse. In some embodiments, the user interface devices 220 may also comprise a keypad and buttons, such as that found on a cellular telephone, such as the cellular telephone 114, or remote control to a set top box 116. For example, with a remote control, arrow buttons on the remote control can move a mouse pointer being shown on a display screen and an “OK” button on the remote control can emulate the action of a left mouse button. Also, the numeric keypad on the remote control can emulate a triple tap keypad, as often used in cellular telephones. With a triple tap keypad, the repeated pressing of a numeric keypad button allows a user to choose amongst several different characters associated with the respective keypad button. A character is set after one second has passed and the keypad button has not been pressed again or if another keypad button is pressed. To demonstrate, FIG. 3 is a table of characters associated with respective keypad buttons (see FIG. 4) of one implementation of a triple tap keypad. Other approaches are also often employed, such as T9 text input, but these approaches also have their limitations and cause frustrations with users.

The one or more network interface devices 240 comprise the hardware with which the computing device 110 transmits and receives information over the network 120. By way of example, the network interface devices 240 include components that communicate both inputs and outputs, for instance, a modulator/demodulator (e.g., modem), a radio frequency (RF) or other transceiver, a telephonic interface, a bridge, a router, etc.

The memory 210 comprises various software programs including an operating system (O/S) 260 and a network client 270. According to exemplary embodiments, the operating system 260 controls the execution of other software, such as the network client 270, and provides scheduling, input-output control, file and data management, memory management, and communication control and related services. The network client 270 is configured to enable connection and navigation of the network 120. By way of example, the network client can comprise a web browser such as Internet Explorer® from Microsoft® or Mozilla Firefox®. In some embodiments, the network client 270 may comprise an application within the set top box 116, such as a menu interface or electronic program guide that allows a user to search program listings or make queries for information from the network 120. Similarly, in some embodiments, the network client 270 may comprise an application residing on a portable electronic device, such as the cellular telephone 114, a Blackberry® unit, an Ipod® device, etc., that facilitates communications with the network 120. According to exemplary embodiments, the network client 270 is configured to receive an input or inputs provided by a user of the computing device 110 and attempt to determine a desired search string by considering a context surrounding the input or inputs.

Although the operating system 260 and the network client 270 are programs identified in the memory 210, persons having ordinary skill in the art will appreciate that other programs may be stored within the device memory, if desired. Additionally, while the network client 270 and other programs may be illustrated as a single software component, this is a non-limiting example. In at least one embodiment, the network client 270 may include one or more components, embodied in software, hardware, and/or firmware. Additionally, while the network client 270 and other programs may be depicted as residing on a single computing device, network client 270 may include one or more components residing on one or more different devices.

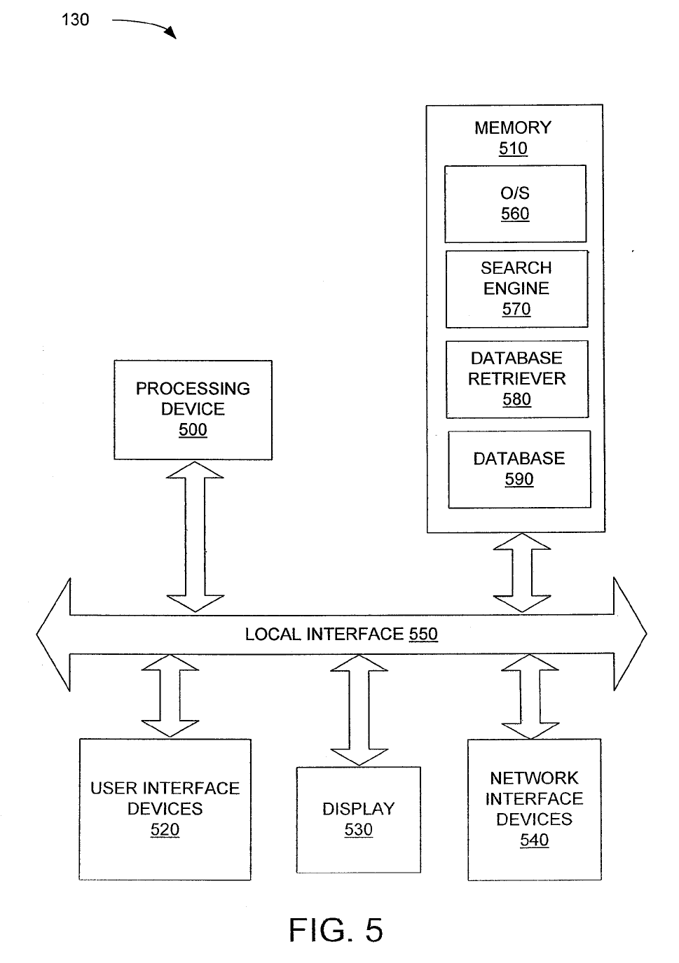

FIG. 5 is a schematic view illustrating exemplary architecture for the network server 130. As indicated in FIG. 5, the network server 130 can have a configuration similar to that of the computing devices 110. Accordingly, the network server 130 can comprise a processing device 500, memory 510, one or more user interface devices 520, a display 530, one or more network interface devices 540, and a local interface 550 to which each of the other components electrically connects. The processing device 500 can include any custom made or commercially available processor, a central processing unit (CPU) or an auxiliary processor among several processors associated with the network server 130, a semiconductor based microprocessor (in the form of a microchip), or a macroprocessor. The memory 510 can include any one of a combination of volatile memory elements (e.g., random access memory (RAM, such as DRAM, SRAM, etc.)) and nonvolatile memory elements (e.g., ROM, hard drive, tape, CDROM, etc.).

As with the computing devices 110, the user interface devices 520 for the network server 130 can comprise a keyboard and mouse, and the display 530 can comprise a computer monitor. The one or more network interface devices 540 comprise the hardware with which the network server 130 transmits and receives information over the network 120 and can include components that communicate both inputs and outputs, for instance, a modulator/demodulator (e.g., modem), a radio frequency (RF) or other transceiver, a telephonic interface, a bridge, a router, etc.

The memory 510 comprises various software programs including, but not limited to, an operating system 560, search engine 570, and database retriever 580. The operating system 560 controls the execution of other software, such as the search engine 570 and the database retriever 580, and provides scheduling, input-output control, file and data management, memory management, and communication control and related services. The search engine 570 may be configured to receive search queries and other inputs from the computing devices 110 and to conduct searches based upon the queries. The database retriever 580 may be configured to retrieve information associated with a user in the process of requesting a search query.

Additionally, while the database retriever 580 and other programs may be illustrated as a single software component, this is a non-limiting example. In at least one embodiment, the database retriever 580 may include one or more components, embodied in software, hardware, and/or firmware. Additionally, while the database retriever 580 and other programs may be depicted as residing on a single computing device, the database retriever 580 may include one or more components residing on one or more different devices.

The operation of the search engine 570 and the database retriever 580 is discussed below. In addition to these programs, the memory 510 can include a database 590 that, as described below, can comprise several information databases, each pertaining to information storing a type of information, such as particular content (e.g., program listings), demographic information (e.g., age of user, name of user, etc.), usage history (e.g., what information the user has accessed previously), etc.

One should note that although a single server is illustrated for representing the network server 130, as one of ordinary skill on the art will understand, one or more servers, computers, etc. may be utilized to provide the desired functionality. Similarly, while some of the components of FIG. 1 are illustrated as having a wired connection to network 120, this is also a non-limiting example. In at least one embodiment one or more component may be wirelessly coupled to network 120.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, or transport the program for use by or in connection with the instruction execution system, apparatus, or device.

The computer readable medium can be, for example but not limited to, an electronic, magnetic, optical, electromagnetic, infrared, or semiconductor system, apparatus, or device. More specific examples (a non-exhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM).

Having described an example operating environment 100 for the context search system 100 above, operation of an embodiment of the context search system 100 will now be discussed. In the discussion that follows, a flow chart diagram is provided. It is to be understood that the functional descriptions within the presented blocks and other elements of the flow chart diagram represent modules, segments, or portions of code that include one or more executable instructions for implementing specific logical functions or steps. Persons having ordinary skill in the art will appreciate that alternative implementations are feasible. Moreover, the functions or steps may be executed out of order from that shown or discussed, including substantially concurrently or in reverse order, depending on the functionality involved. Also, features described as being performed by the network server 130 in one embodiment may be performed by the computing device 110 in another embodiment and vice versa. In this way, processing of certain functions and steps may be preferably performed by a client device or a server device in different embodiments.

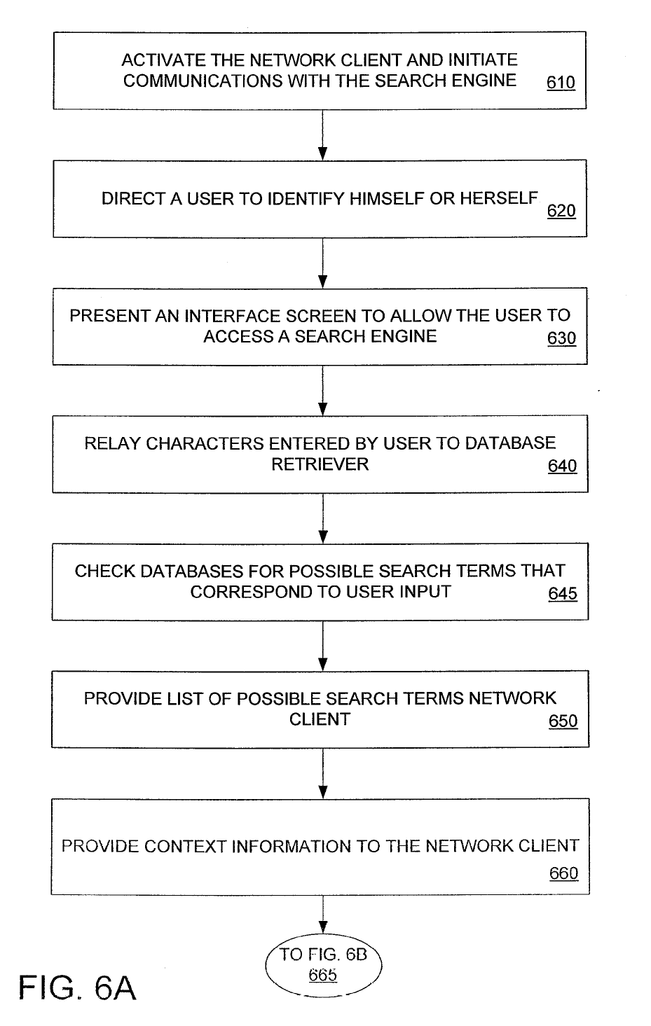

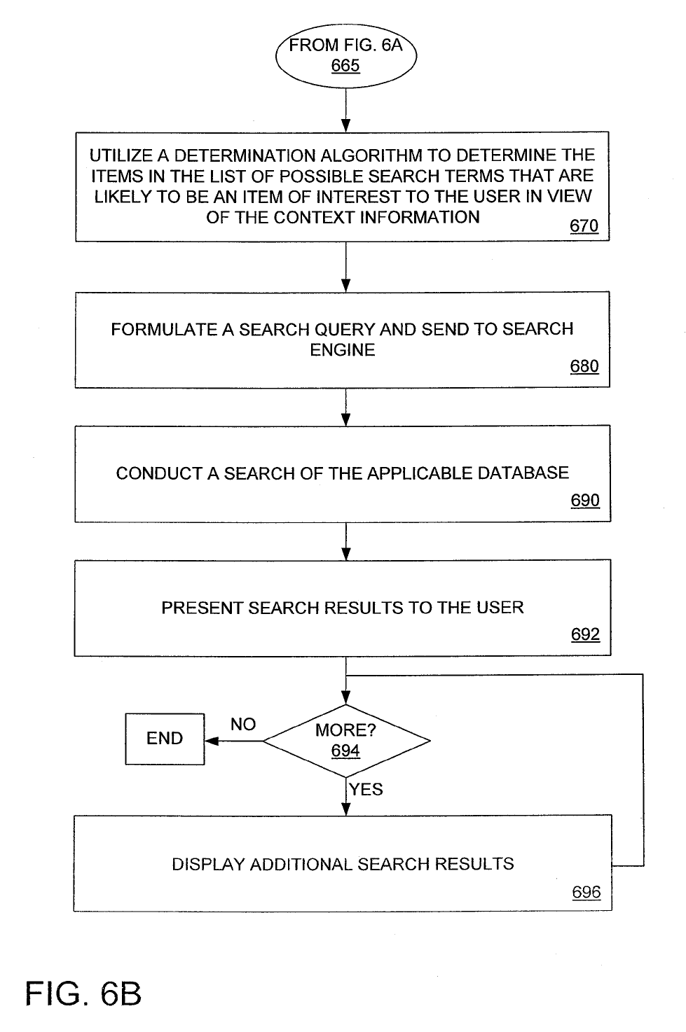

Referring now to the flow chart of FIG. 6A, illustrated is an example of operation of the context search system 100. As indicated in block 610, the network client 270 is first activated and initiates communications with the search engine 570. This activation and coupling normally comprises the accessing of the network client 270 with a computing device, such as the computing device 110, and causing the network client 270 to interface with the search engine 570 via an address (e.g. universal resource locator (URL)) for the network server 130 hosting the search engine, where the address is maintained by the network client 270. According to exemplary embodiments, once the network client 270 has been activated, a login screen is presented to the user and directs (620) the user to identify himself or herself by entering a user PIN (personal identification number). An example interface screen 700 is illustrated in FIG. 7. The identity information provided by the user can be employed by the context search system 100 to acquire information about the user that is stored in the network databases 135. Any other suitable techniques can be employed for identifying user identity without departing from the scope of the disclosure.

The interface screen 700 also demonstrates another method for entering characters (in addition to previous examples that have been mentioned, such as the triple tap approach). This approaches displays a keypad on a display, such as the display 230 of the computing device 110 and allows the user to move a cursor to a keypad button being displayed, where the user can then select a character on the keypad with the press of a button or mouse control on a user interface control of the computing device 110, such as a remote control, mouse, etc.

After the user is authenticated, an interface screen is presented to the user to allow the user to access the search engine 570, as indicated in block 630. In some embodiments, the user may request the interface screen to be shown by selecting a menu option of the network client 270.

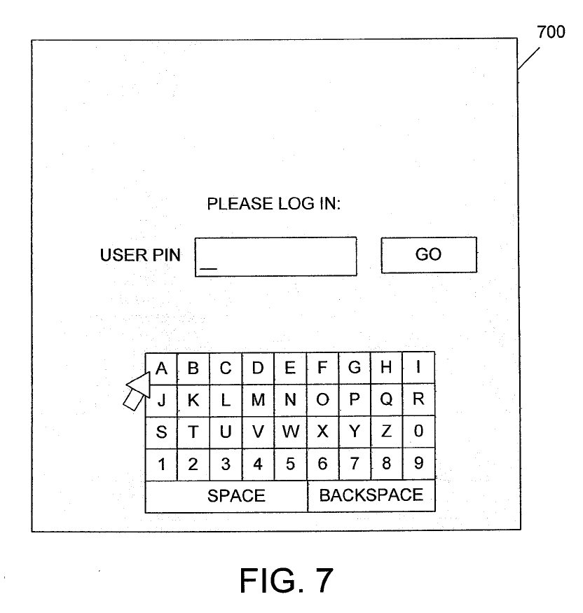

An example interface screen 800 is schematically illustrated in FIG. 8. As indicated in this figure, the interface screen 800 may comprise an input box 810 for receiving character inputs to form a character string 820. A drop down box 830 may also be provided for displaying suggestions of the string that the user is attempting to formulate. Further, the drop down box 830 may also contain suggestions of terms or keywords that may be related to the term being entered by the user and may be of interest to the user. If the user finds a desired term in the drop down box 830, the user may discontinue entering the character string in the input box 810 and move a cursor down to the desired term in the drop down box 830 and select an “Enter” keypad button (or similar button) or use a mouse click to indicate that a search should be performed on that entry in the drop down box 830. Further, as a user enters a character into the input box 810, the entries in the drop down box 830 may dynamically adapt and change to conform with the present character string in the input box 810, although the user may have only entered a few characters of the search term that the user was intending to provide.

Returning to FIG. 6A, the database retriever 580 sends the network client 270 possible keywords or entries based upon the characters provided or entered by the user that are relayed (640) to the database retriever 580 by the network client 270. Therefore, the network client 270 and database retriever 580 share information back and forth. Accordingly, if the user has entered the string “Joh” in the input box 810, the network client 270 provides this information to the database retriever 580 which then checks (645) databases for possible search terms that correspond to the “Joh” input. Therefore, in a television environment, the database retriever 580 may provide possible search terms, such as John Wayne, Johnson Ferry Church Service, Johnny Cash, etc. that are provided in the drop down box 830 to the user, so that if a desired term is found the user can select the term so that a search is then performed on the term. The database retriever 580 therefore retrieves a list of possible search terms and the list is provided (650) to the network client 270.

The amount of information capable of being displayed at one time by the network client 270 and display 230 of the computing device 110 may be limited, especially in the case of a small portable device, such as the cellular telephone 114, or a device having limited input capabilities, such as the set top box 116 (with remote) and display. Therefore, not all of this information is shown at one time. In accordance with the present disclosure, components of the context search system 100 attempts to present items in the list that are likely to be desired by the user given the context of the search. Therefore, in addition to the search results, the database retriever 580 provides (660) to the network client 270 context information that is used to determine or deem which items in the list should be presented to the user and, in exemplary embodiments, the order in which the items should be presented to the user. Context information may include a variety of information from a variety of sources. For example, demographic information on the user may be supplied, such as whether the user is a head of a household or a child in the household, whether the user is male or female, the age of the user, the location where the user resides, etc. Also, seasonal information or a current chronological state may be considered, such as whether the time of the year is in the summer, close to a holiday, whether the time of the day is in the morning, afternoon, or night, etc. Past usage history of the user may also be provided, such as past browsing statistics of the user, past viewing history, etc. Additional sources and types of information may also be used as context information.

The flow chart diagram continues (665) on FIG. 6B. Here, the network client 270 receives the list of possible search terms and context information and utilizes (670) a determination algorithm to determine the items in the list that are likely to be an item of interest to the user in view of the context in which the search is being made. For example, if a user enters the term “Miami” in the input box 810 of the search interface 800 without considering any context information, the term may be as likely to refer to Miami, Fla.; Miami Vice; Miami Sound Machine; Miami Hurricanes, etc. However, if context information provides further information such as the fact that the present day is the day of the National Football League Championship (also known as the Super Bowl); the user often watches NFL football and especially watches the Miami Dolphins; and it is known that the Miami Dolphins are featured in this year's Super Bowl, then the term is highly likely to be referring to the Miami Dolphins or the Super Bowl featuring the Miami Dolphins. Therefore, Miami Dolphins and the Super Bowl will be the first terms listed in the drop down box list.

The determination algorithm uses pattern recognition to recognize a common pattern from a variety of instances and descriptions of information in order to make a determination of which items in the search term list are more relevant in view of the context information that has been provided. The context information itself may contain information that has been previously analyzed by the server 130 in the network 120. For example, a variety of usage parameters may be compiled regarding a user, such as the content he or she accesses, the amount of time that the content is accessed, past search queries, items purchased using the computing device 110, information downloaded, such as videos and songs, etc. This type of information may be compiled and analyzed to form an index ranking of the user in a variety of categories, such as the user's interests in sports, westerns, cartoons, etc., in a television environment, for example. This index ranking may be passed to the network client 270 to be used in the determination algorithm.

The network client 270 may execute a series of pre-defined rules in order to predict items of interest to the user. According to exemplary embodiments, the network client 270 is provided context information from one or more of the databases 135 in order to make the predictions.

As the user enters another character into the input box, the network client 270 may provide this information to the database retriever 580 which responds by providing a list of items to which the character string may refer and the determination algorithm is used to choose items from the new list of items to show in the drop down box 830. Accordingly, the items displayed in the drop down box 830 dynamically change and adapt as the user enters additional characters into the input box 810. Although the drop down box 830 is shown and described, persons having ordinary skill in the art will appreciate that many other means for providing options to a user for selection could be used.

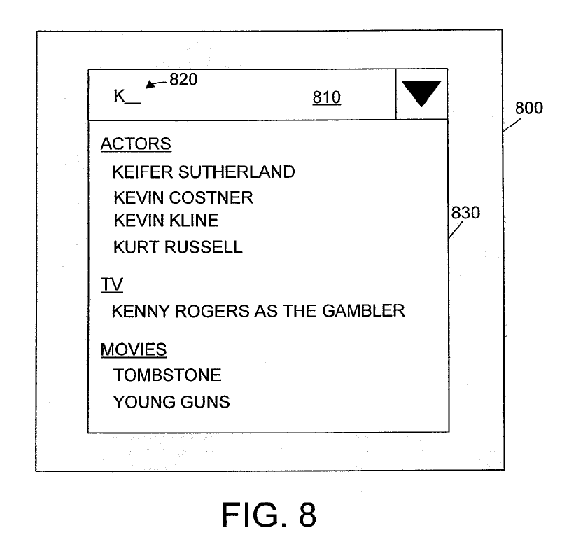

The relationship amongst the database retriever 580 and the databases 135 the retriever communicates with is schematically illustrated in FIG. 9. As indicated in this figure, the database retriever 580 is linked to several different databases 910 storing computing device information 920 (such as the location of the computing device—e.g., the den), purchasing information 930 (e.g., prior purchases made via the computing device, pay-per movies, etc.), search queries 940 (e.g., prior search terms used in prior search queries), digital video recorder (DVR) selections 950 (e.g., prior recordings and season pass selections made on a DVR), user demographics 960 (e.g., age, gender, stated interests, etc.), seasonal information 970 (e.g., current date, time, current chronological state, etc.), user ratings 980 (e.g., ratings of content, such as movies, television shows, books, etc.), program listings 990 (e.g., a listing of content available to be viewed, purchased, or accessed), and viewing habits 995 (e.g., a history of viewing habits of user), among others. It is to be understood that the database retriever 580 may have access to the databases 910 containing information having parameters to be used in determining a context for a search. In some embodiments, to compile information maintained in one or more of the databases 910, the network client 270 feeds data inputted by a user to the databases 910. In a television embodiment, a preference server (e.g., a type of network server) may catch searched words each television viewer has entered and records the context in an applicable database. Also, channel settings, such as which channels are favorites or have been blocked, may be recorded.

Additionally, a viewer is provided the ability to interact and access an extraordinary amount of content relating to a program being viewed. For example, information content, such as, e.g., textual content, production credits, filmographies, character descriptions, award information, genre information, information relating to audio, information relating to video, and promotional information, etc. may be viewed. A viewer may also access interactive components such as, e.g., but not limited to, trivia, quiz, postcards, polling, gaming, etc. An interactive interface may be used to provide access to alternative audio/video (AV) experience such as, e.g., but not limited to, alternate video and audio tracks, including e.g., alternate resolution tracks, interviews, “making of” videos, behind the scenes clips, trailers, alternate camera angle tracks, alternate special effects, alternate subtitles, ratings tracks, foreign language tracks, promotional tracks, closed captioning, director commentary, deleted scenes tracks, etc. As previously mentioned, viewing habits such as what pay per view movies have been viewed, what channels are tuned in by the user, what shows are recorded on a DVR, what advertisements are selected by a user, which searches are made on a Yellow Pages search, etc. may be useful in determining a context and stored in the network database 135. Generally, each selection made by a user or household representative within the network client 270 is a possible entry into one of the databases 910 in specific detail.

Based on this information and other information maintained in the databases 910, preferences of a user may be learned and context in which a search is being made may be considered when a search is being sought by a user. In this way, a personal preference and context-based keyword search may be performed by embodiments of the context search system 100. Each keyword entered or selected by a user may be used to continuously update a database storing such information thus refining this information as additional searches are performed. Each of these selections and choices made by a viewer may be provided as data to one or more of the databases 910. Therefore, in one embodiment, more than 1000 different parameters may be used to define what context is.

In many networked environments, a lot of information is known about users of the network which is advantageous in implementing embodiments of the disclosure. For example, in an IPTV environment, since each user is a subscriber to the IPTV service, the user's habits of viewing or browsing can be captured. This provides a smarter way to perform a search based on keywords. Similarly, web-based networks such as Amazon capture and maintain information on their users which could be used as context information in accordance with the present disclosure.

Further, based on the identity the user enters, the role the user has in a household may be determined (e.g., whether the user is a parent or a child). From the identification number of a set top box, the room in the house where the box is located may be determined. With use of such information in a search process, the speed of the search process is improved.

As previously stated, a wealth of information is available on the Internet and/or television network, such as thousands of titles in a program guide, pay per view titles, and longtail video and audio content available from podcasts. By using an embodiment of the context search system 100, all this information may be made available to a user in a more ordered sense, in what the user wants to find, and in what the user has shown his/her interests to be. This is all done passively in the background of the context search system 100 as a user browses or views content over the network 120. And, possible keywords that may be of interest to a user are presented to the user at the point of entry of a search query.

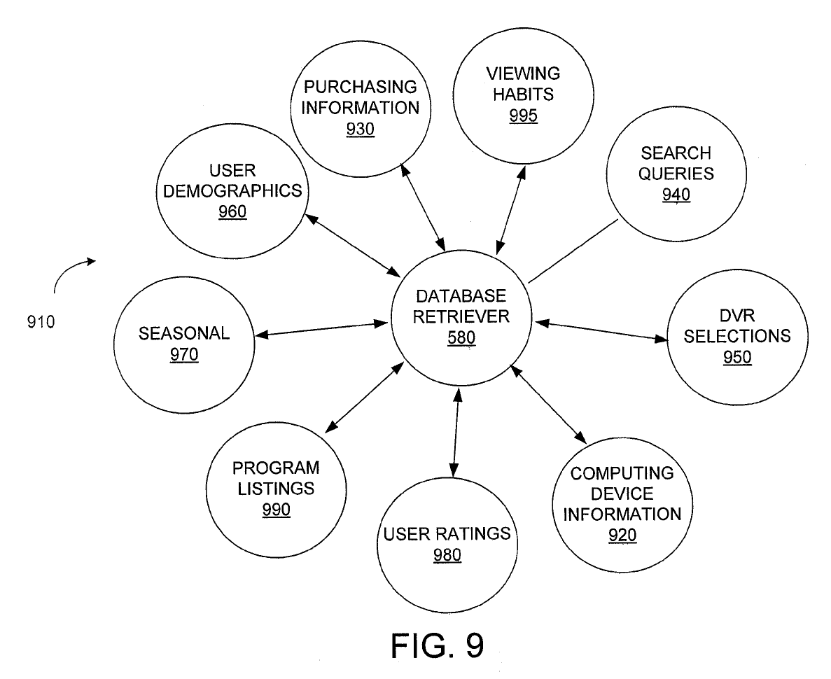

FIG. 10 illustrates logic of the network client 270 in implementing the determination algorithm. In FIG. 10, the logic of the network client 270 is represented as block 1010. Input 1020 to the network client logic 1010 includes the character string provided by the user, context information received from a variety of the databases 135 for the search, and possible search terms received from the network server 130 based on the character string. The network client logic 1010 considers this information in order to select a subset of the possible search terms that are more likely to be of interest to the user attempting to input the search term, which is an output 1030. The character string itself may be provided as the input 1020 to the network client logic 1010 for comparison purposes with the items in the list of possible search terms, where an item that has the characters of the character string may be considered a more likely match than another item that does not have the characters in the search string.

Referring back to FIG. 6B, once a user has inputted a search string whether by typing a whole character string or selecting an item from the drop down box 830, a search query is formulated by the network client 270 and sent to the search engine 570, as indicated in block 680. The search engine 570 receives the query and conducts a search of the applicable database, as indicated in block 690. In formulating the search query, words may be removed that are not deemed to be important to the query such as articles “a,” “an,” and “the” or conjunctions such as “or” and “and” or common prepositions, etc. Also, words that are more distinct may be weighted more than words or terms that are commonly found. For example, in the title “Jurassic Park”, the term “Jurassic” would be given more weight than the term “Park.”

In operation, the search engine 570 can search content associated with the Internet according to the received search criteria. Upon completing the search, the search engine 570 can provide data (which may take the form of source code) that includes an address associated with content revealed in the search. Upon receiving the data, the network client 270 associated with the computing device 110 can determine a format for displaying the received information. The user can then select at least one of the addresses. Upon receiving the user selection, the search engine 570 can provide the computing device 110 content from a server associated with the selected address.

Returning to FIG. 6B, once the search has been conducted by the search engine 570, the search results can be presented to the user, as indicated in block 692. By way of a non-limiting example, the results can comprise titles and/or brief descriptions of one or more program listings, podcasts, network sites (e.g., web sites), network pages (e.g., web pages), documents, audio/video tracks, etc. At this point, the user is free to select and/or review one or more of these results, if desired.

In accordance with the present disclosure, the network client 270 may sort or organize the search results in a similar manner as the search terms were arranged. In other words, the network client 270 may use the determination algorithm and context information previously provided to determine which of the search results is more likely to be of interest to the user. For example, if a search was done on a movie title, and the search results included cast information (that contains hyperlinks), director information (that contains hyperlinks), and the times (with hyperlinks) in which the movie title is to be broadcasted, prior viewing habits of the user may indicate that the user is more interested in director information (since the user often visits hyperlinks in the director information) than cast information. Therefore, the director information is shown before the cast information in an interface displaying the search results.

With reference to decision element 694 of FIG. 6B, it can then be determined whether the user would like to receive additional search results if the search results that were displayed were not what the user desired. Therefore, the next subset of search results that were identified by the determination algorithm to be of likely interest to the user is displayed (696).

In presenting the search results or the list of possible search terms for display, the network client 270 may be configured to display at a high level, categories that are likely to be of interest to the user. For example, in the case of a user entering a character string for search purposes, the drop down box 830 of possible search strings or terms may contain category entries that are likely to be applicable to the term in which the user is interested. For example, if the user enters “John,” then the user may be presented with the categories of Actors, Athletes, and Musicians instead of Politicians, Chefs, and News Anchors, since the viewing habits and other context information may indicate that the user is more likely to be searching for an actor, athlete, or musician. Therefore, if the user selects the Actors categories, items in the list of possible search terms that refer to actors are identified and the more likely of these identified items to be of interest are shown to the user. It is noted that display space may be limited, so only a few search terms may be displayed at a time. Similarly, in some embodiments, categories may be displayed with the most likely items under each category displayed and presented to the user.

In one embodiment, each possible category relates to a different aspect that differentiates between the search results or terms, as the case may be. The available categories may be ranked according to a priority based on context information. According to exemplary embodiments, the network client 270 selects a category that is of the highest priority and will provide a reasonable distribution of the search results or terms. Once the category is determined, the search results/terms are then divided into groups corresponding to the category. The items within each category may be criteria associated with the category. For example, if the category is “actors,” the items in the category are likely to be different actors and the actors deemed to be the most likely actors of interest to the user are displayed first.

During browsing or viewing of search results presented to the user, a user may indicate that the methodology being used to present the search results is on the wrong track. For example, a user may be provided a list of action movies when the user is actually interested in romantic comedies. In some embodiments, to let the network client 270 become aware of this, a user is provided a graphical button that the user can activate which will cause the determination algorithm to modify or rescale the factors the algorithm is using to determine likely search terms or results, as the case may be. Likewise, if a user believes that a proper methodology is being used and the items being presented are close to being a match to what the user is desiring, the user can activate a button to let the network client 270 become aware that items similar to the ones previously shown should be presented to the user.

The foregoing features and additional features of embodiments of the context search system are illustrated and described in the following examples and figures.

Referring back to FIG. 8, the figure is a diagram illustrating an exemplary user interface, such as a search engine graphical interface that may be provided by the search engine 570. More specifically, the non-limiting example of FIG. 8 includes the interface display 800 with the input box 810. In the present example, the use has entered the string “K” into the input box 810. In response to this received input, the drop down box 830 is displayed with items that are deemed to be possible matches to the string being entered or to the item that the user may be attempting to find in his or her search results.

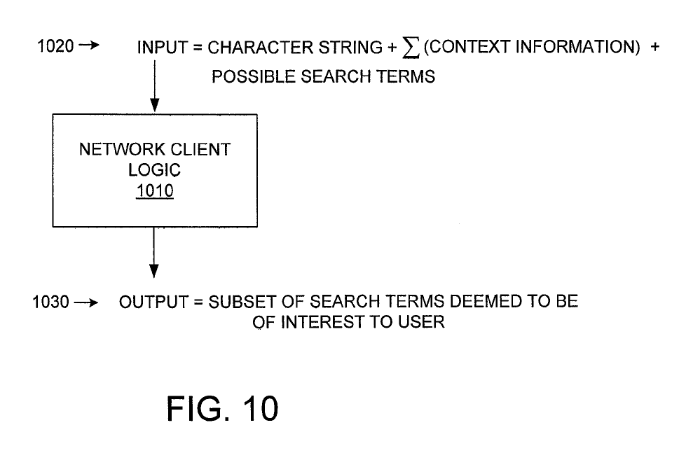

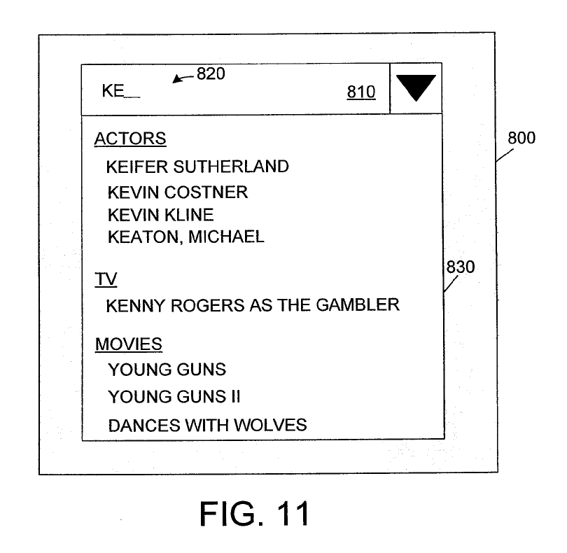

In the present example, the user is assumed to watch a lot of movies and television, as evidenced by the user's browsing and viewing habits which have been collected and maintained in the network databases 135. Since this information is known about the user, the drop down box 830 is populated with possible items of interest that may correspond to the user's character string input, such as a list of actors whose first name begins with the letter K. In FIG. 11, the same interface is shown except that another character has been inputted by the user. The character string 820 is now “KE.” This string 820 is received by the network client 270 and provided to the database retriever 580. The database retriever 580 compiles a new list of possible search terms based upon the new character string. As shown, the items in the drop down box 830 have changed in response to the new character string. For example, “Kurt Russell” is no longer listed. A reason for this may be that “Kurt” does not begin with the letters “KE” which is the current character string 820. Likewise, in FIG. 12, the character string 820 is now “KEVIN” in the present example. In response, the items in the drop down box 830 have changed from the items shown in FIG. 11. In FIG. 12, the most likely items of interest are actors “Kevin Costner” and “Kevin Kline” and a list of movies. It is also to be noted that the items displayed in the drop down box 830 may be limited to only showing items that are scheduled to be broadcasted or are associated with a movie/show that is to be broadcasted, when a television environment is being considered.

Also, in accordance with one embodiment, the order in which items are displayed in the drop down box 830 is arranged in accordance to which items are deemed to be of most interest to the user. For example, in FIG. 12, based upon the character string “KEVIN” and the context information available to the network client 270, the network client 270 deems that the user is more likely to be interested in Kevin Costner than Kevin Kline.

In FIG. 12, it is assumed that the user chooses to select “Kevin Costner” as the subject of a search query. In one embodiment, the user may move a cursor over the term “Kevin Costner” and then select an Enter button on a remote control or keypad or click a mouse button. In response, search results are then displayed.

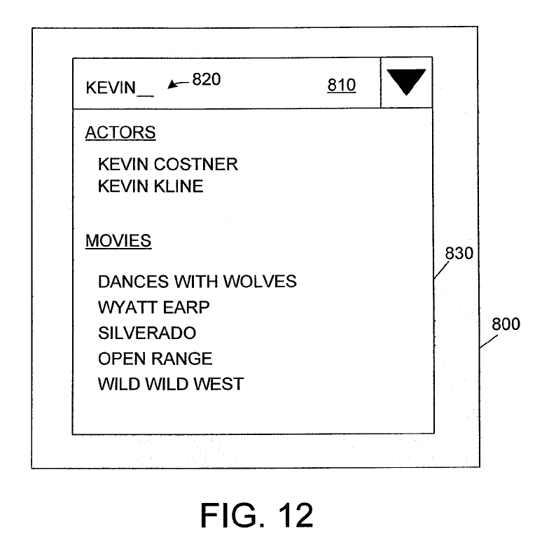

FIG. 13 shows one embodiment of a screen interface 1300 for displaying the screen results. In the present example, a list of movies are shown that feature Kevin Costner and are available to be viewed over a television network.

In accordance with one embodiment, a mechanism is provided for a user to indicate whether the search results being displayed are of the type that the user is interested in receiving. In the example of FIG. 13, a user can select a “Right Way” button 1310 to indicate that the right type of items from the search results are being displayed to the user. In this way, the user is indicating that the network client 270 is on the right track or way. Likewise, the user can select a “Wrong Way” button 1320 to indicate that the wrong type of items from the search results are being displayed to the user. In this way, the user is indicating that the network client 270 is on the wrong track or is heading the wrong way. An arrow 1330 may also be selected to go back to the prior screen, which in the present example is the search interface of FIG. 12.

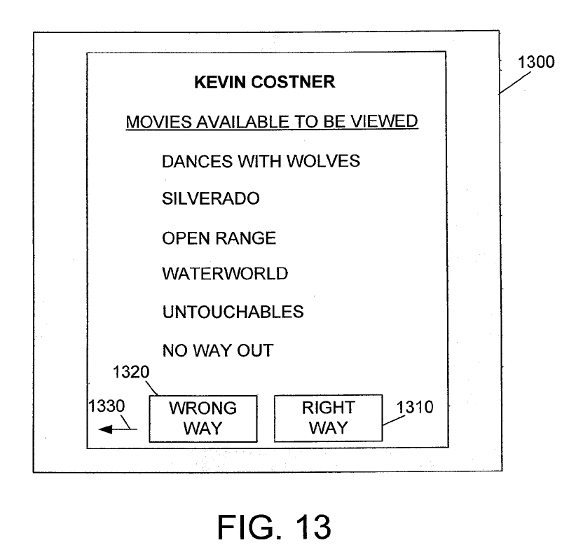

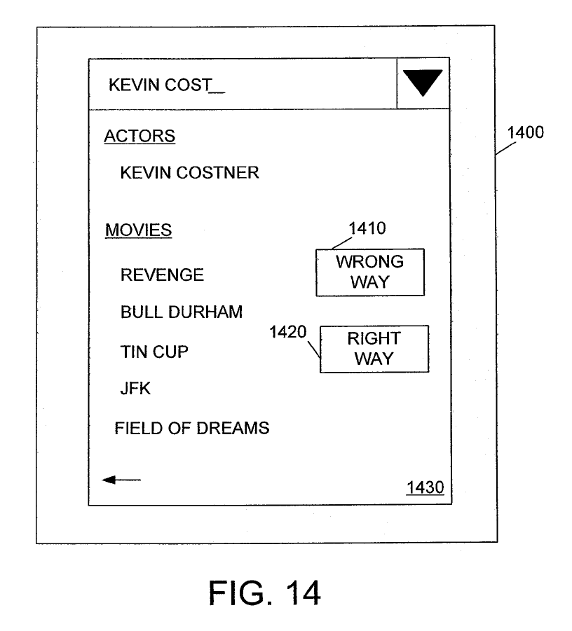

In some embodiments, Wrong Way and Right Way buttons 1410, 1420 are also provided in a drop down box 1430 of a search interface 1400. For example, in FIG. 14, the drop down box 1430 shows actor “Kevin Costner” and movies “Revenge,” “Bull Durham,” “Tin Cup,” “JFK,” and “Field of Dreams.” If the user is interested in finding a certain Kevin Costner movie but the movie of interest is not like the movies listed, the user can select the Wrong Way button 1410. In response, the drop down box 1430 may show new items from the search results. In the earlier example of FIG. 14, the movies were action and sport-themed movies. However, in the drop down box of FIG. 15, more romantic-themed movies are listed.

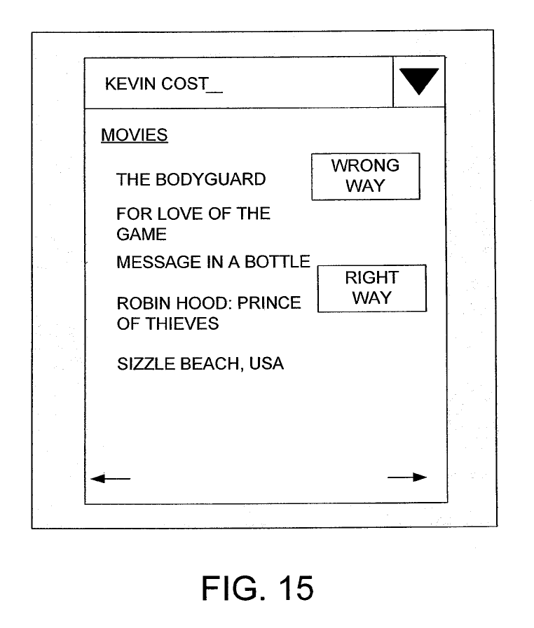

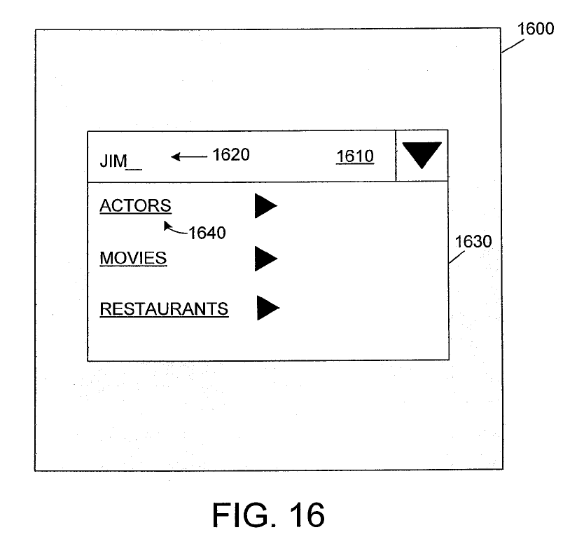

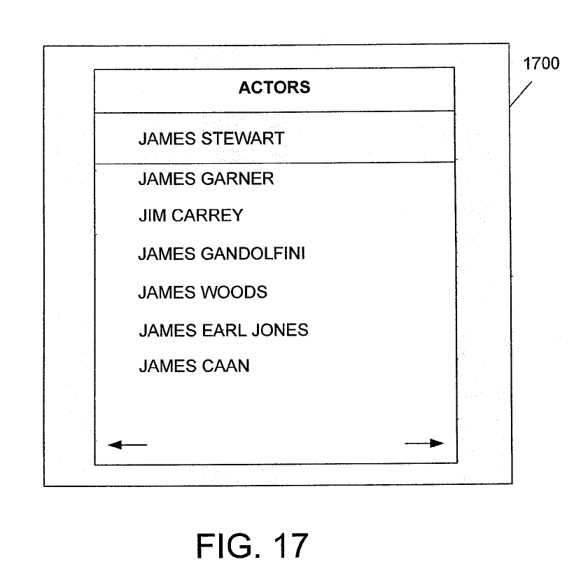

In another scenario, consider a user using a search interface 1600 of FIG. 16 where the user has entered a string “JIM” 1620 into an input box 1610. In response, a drop down box 1630 is displayed. The drop down box 1630 displays three categories: Actors 1640, Movies, and Restaurants. When each category is selected, the drop down box 1630 displays a subset of possible search terms that fit the category and are deemed to be possible matches to the user's character string 1620. For example, the user could be looking for the movie “Jim Thorpe—All American” or the restaurant “Jim's Crabshack.” In the present example, however, the user selects the Actors category 1640 and is displayed on an interface 1700 of FIG. 17. Here, possible matches for the user's character string 1620 are shown that correspond to the category Actors 1640 and are deemed to be likely of interest to the identified user. It is observed that the matches contain actors with the name “James” which is deemed to be a variant of the character string “Jim” by the database retriever 580. From the shown matches, the user selects “James Stewart” as a desired match. In response, a search is performed by the search engine 570 on the selected search term. FIG. 18 shows an example search result provide on an interface 1800. Here, movies starring James (Jimmy) Stewart are shown.

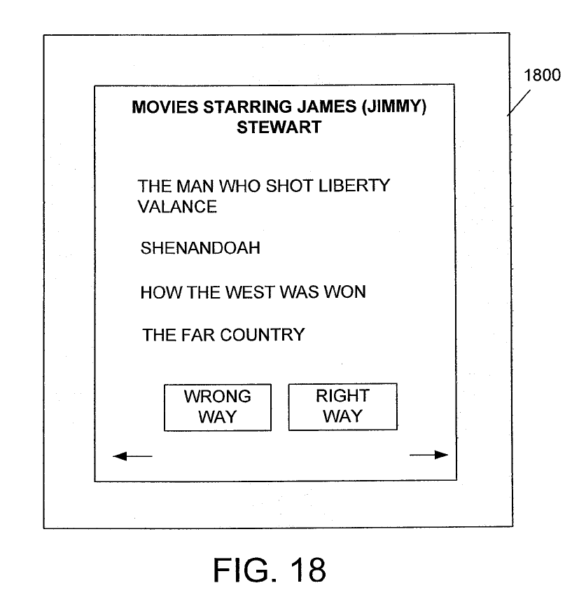

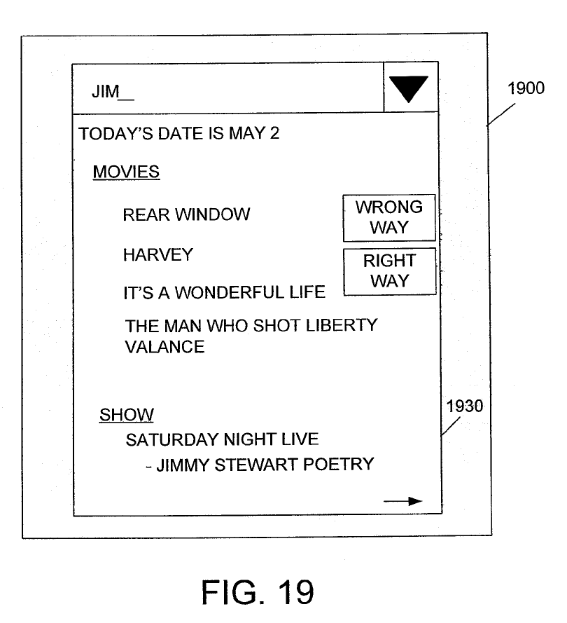

In another example, FIG. 19 and FIG. 20 show drop down boxes and possible matches to the character string “Jim” for the same user (who is not necessarily the same user from other example scenarios). However, the interfaces are being accessed on different dates. In the example of FIG. 19, an interface 1900 displays a date of May 12. On this date, the possible matches shown in a drop down box 1930 are “Rear Window,” “Harvey,” “It's a Wonderful Life,” and “The Man Who Shot Liberty Valance.” In comparison, the example of FIG. 20, an interface 2000 displays a date of December 24, which is the eve before Christmas. On this date, the possible matches shown in an drop down box 2030 are “It's a Wonderful Life,” “Mr. Krueger's Christmas,” “Harvey,” and “The Man Who Shot Liberty Valance.” Given the same character string and the same user, different items and/or different ordering of items may be presented. In the present example, the search being considered in FIG. 20 occurs on Christmas Eve, where the tendency to watch or access Christmas-themed content is much higher than it would be in May. Therefore, context information may include calendar date information or a current chronological state. In a similar manner, some content may be more likely to be watched in the mornings (e.g., news, cartoons) than at other times of the day. Therefore, consideration of what time of day it is may be used to consider the context in which a search or search terms are being provided or requested.

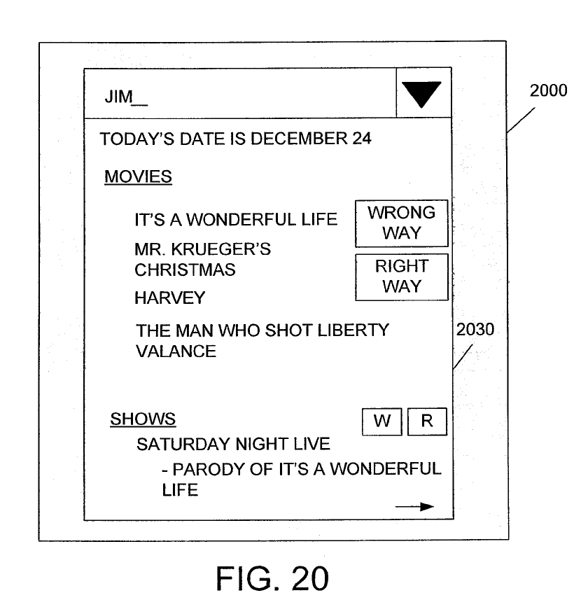

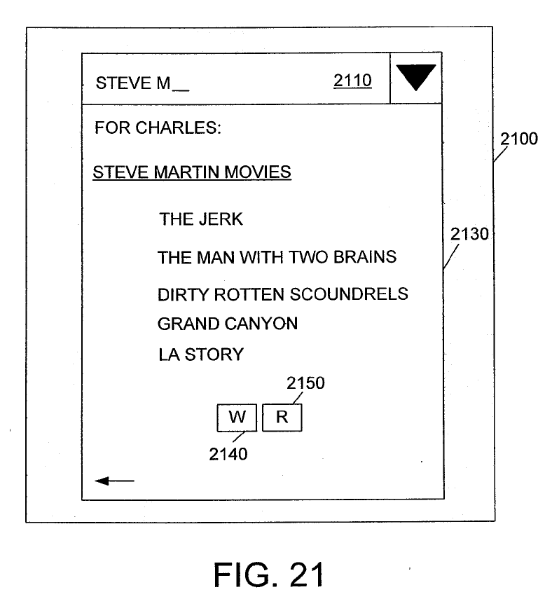

To further illustrate how context information may shape how information is presented to a user, consider the figures of FIG. 21 and 22. In FIG. 21, a user named Charles who is known to be an adult male that likes to watch mature-themed comedies enters the character string “Steve M” in an input box of a search interface 2100. In response, a drop down box 2130 is displayed listing Steve Martin movies, many or all of which are mature-themed or comedies intended for mature audiences. Comparatively, in FIG. 22, a user named Lucy who is known to be a pre-teen female that likes to watch movies geared towards a young audience enters the same character string “Steve M” in an input box of a search interface 2200. In response, a drop down box 2230 is displayed listing Steve Martin movies, many or all of which are movies intended to be viewed by young audiences. As previously mentioned, the network client 270 can learn the identity of a current user by requiring or prompting the user to authenticate himself or herself. Also, of note, in the present examples, a Wrong Way button (of earlier examples) is represented using shorthand notation with a W button 2140, 2240 and a Right Way button is represented using an R button 2150, 2250.

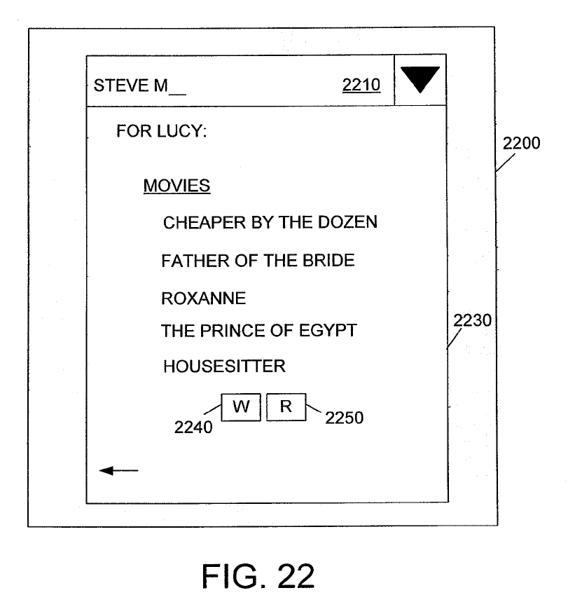

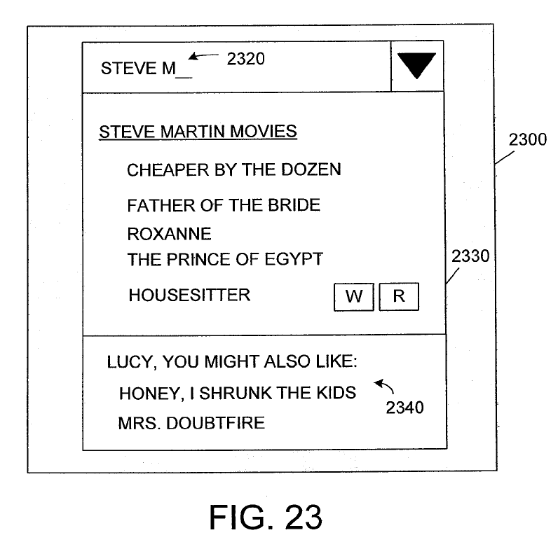

In one embodiment, in addition to finding possible matches to a search string and presenting information in a desirable way given the context in which information is inputted by a user, recommendations may be provided to the user on additional information that may be of interest to the user. For example, in the illustration of FIG. 23, a drop down box 2330 of a search interface 2300 may also dedicate a section 2340 towards recommendations that do not necessarily correspond to a search string 2320 but is deemed to be of likely interest to the user. One way that such a determination may be made is to consider user-ratings or feedback from persons that have viewed the items in the drop down box 2330. For example, if persons that have watched “Cheaper by the Dozen” have also indicated that they really like “Honey, I Shrunk the Kids,” then this may be recommended to a user who has “Cheaper by the Dozen” in his or her drop down box. Further, in some embodiments, user-ratings from persons of the same demographic as a user may only be considered when making recommendations to the user. Similarly, in one embodiment, recommendations may also be made as part 2410 of an interface 2400 showing search results, as demonstrated in FIG. 24.

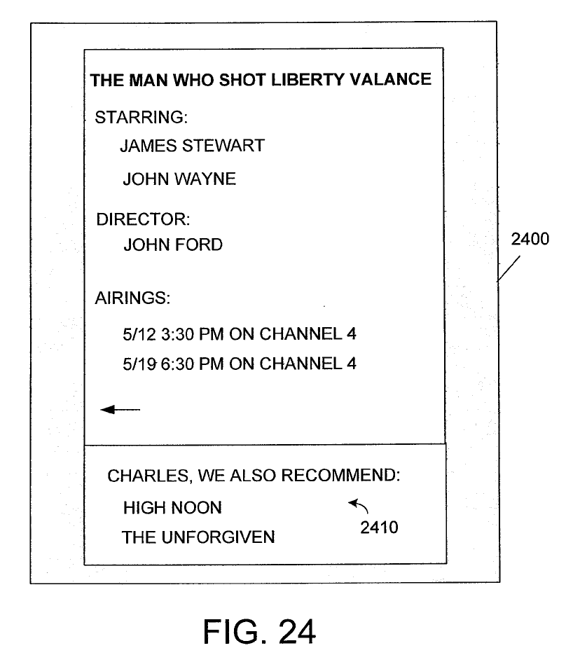

Referring now to FIG. 25, an embodiment of a search interface 2500 used in some embodiments of the context search system 100 is shown. With the interface 2500, radio buttons 2520 are provided to designate whether a specific search or a general search is desired. With a specific search, only possible search term matches are provided in a drop down box that contain the character string provided by a user in an input box 2510. With a general search, possible search term matches may be provided that do not contain the character string provided by the user.

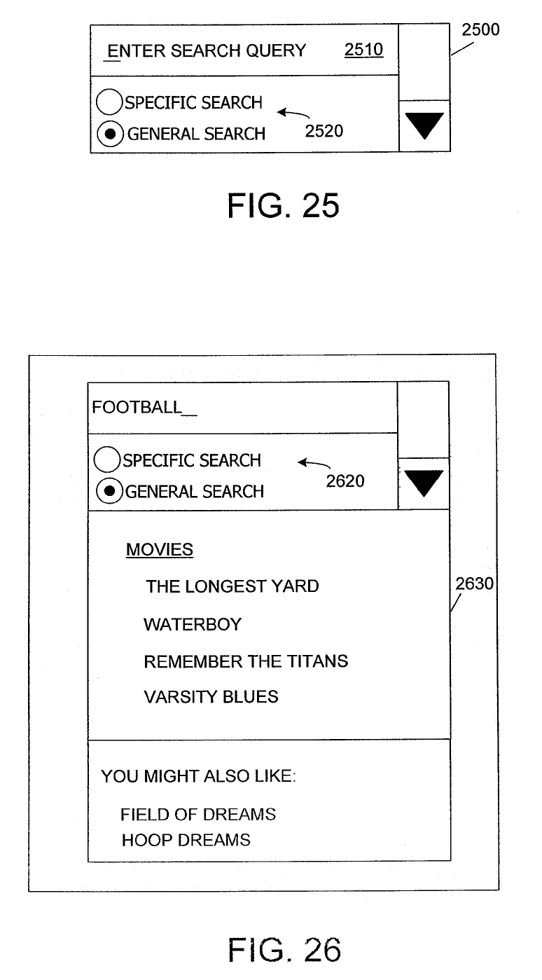

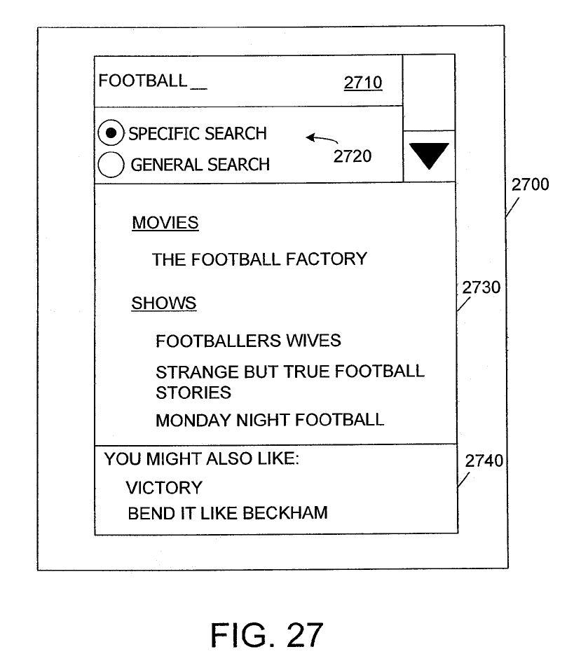

Accordingly, in FIG. 26, a general search button of radio buttons 2620 has been selected and the character string “Football” has been inputted by a user. In response, possible search terms in a drop down box 2630 include items that do not contain the term “Football” but are related and correspond to the term. For example, movies having to do with American football are presented in the drop down box 2630. For comparison purposes, FIG. 27 shows a search interface 2700 and drop down box 2730 where the string “Football” has been entered in an input box 2710, and a specific search option 2720 has been designated. In response, all the movies and shows in the possible search term matches have the term “Football” in their title. It is also observed that several of the items most likely to be of interest to the user include shows in the example of FIG. 27 where FIG. 26 was populated with movies.

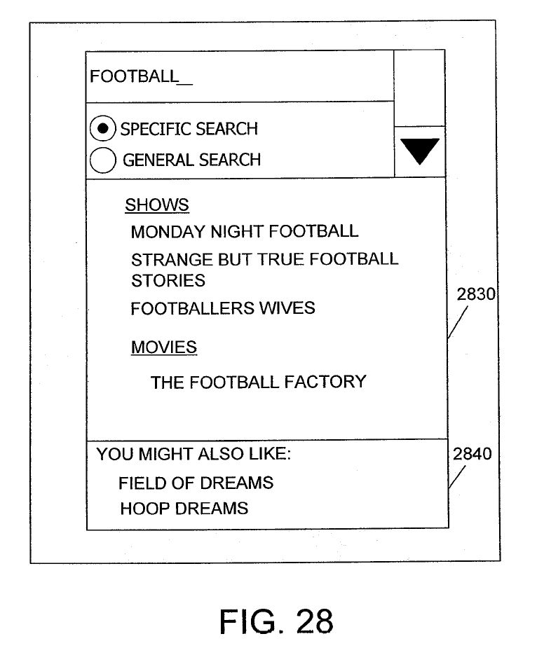

In the example of FIG. 27, a user is assumed to be a fan of soccer or European football and this information may be determined from the user's viewing habits, browsing habits, purchasing history, DVR recordings, etc. With knowledge of this information, the network client 270 may present the items in the drop down box 2730 such that the movie involving soccer or European football entitled “The Football Factory” and the television show involving the wives of soccer players entitled “Footballers Wives” are presented higher in the list than the items having to do with American football. It is also observed that the recommendations 2740 made to the user involve movies (“Victory” and “Bend It Like Beckham”) that focus on European soccer as part of their plot. Comparatively, FIG. 28 shows the same interface of FIG. 27. However, the user of FIG. 28 is a fan of American football as may be learned by analyzing his or her context information provided by the database retriever 580. Accordingly, in the list of items shown in a drop down box 2830, shows Monday Night Football and Strange But True Football Stories are presented first, since they are about American football, as opposed to soccer. It is also observed that recommendations 2840 made to the user involve movies (“Field of Dreams” and “Hoop Dreams”) that focus on other popular American sports.

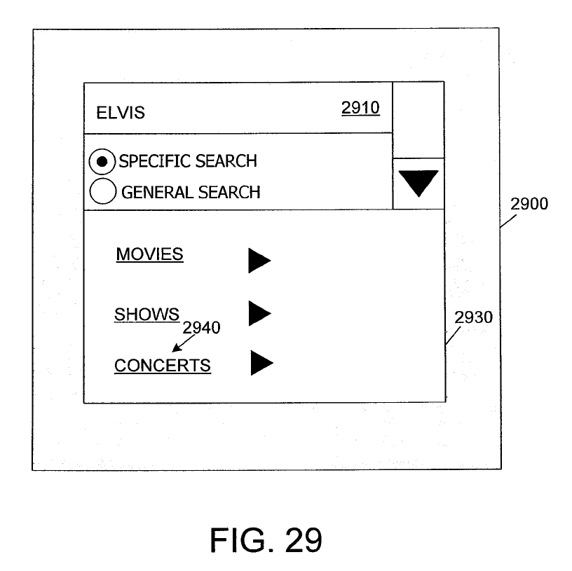

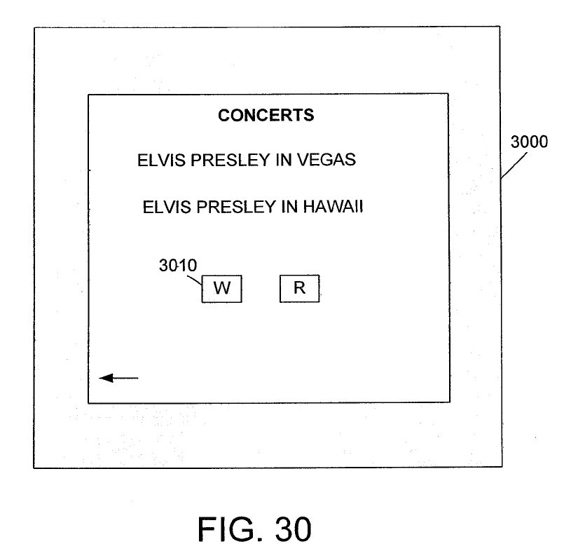

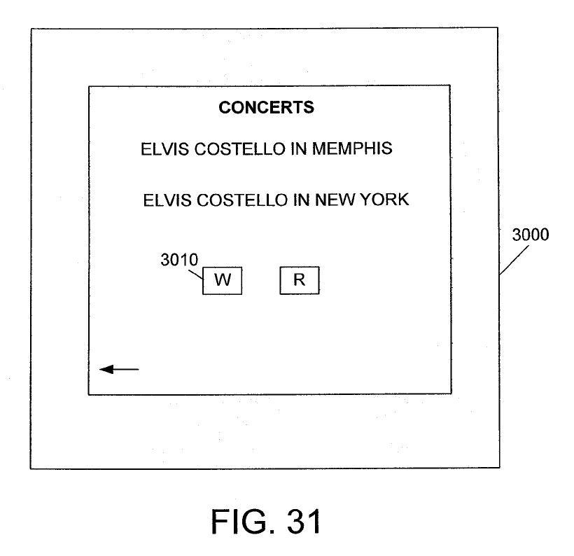

Referring now to FIG. 29, a search interface 2900 is illustrated where the string “Elvis” has been entered into an input box 2910. In response, a drop down box 2930 is provided with categories of possible search terms that may match the string being entered or the desired search result. In the present example, a user selects a Concerts category 2940. In response, an interface screen 3000 of FIG. 30 is displayed with possible search term matches. In the present example, Elvis Presley concerts are listed. However, this is not what the user desired to enter as a search term. Accordingly, the user selects a W button 3010 to indicate to the network client 270 that a new selection of possible matches should be presented that do not involve Elvis Presley. Therefore, the screen interface 3000 is populated with new search choices, as shown in FIG. 31.

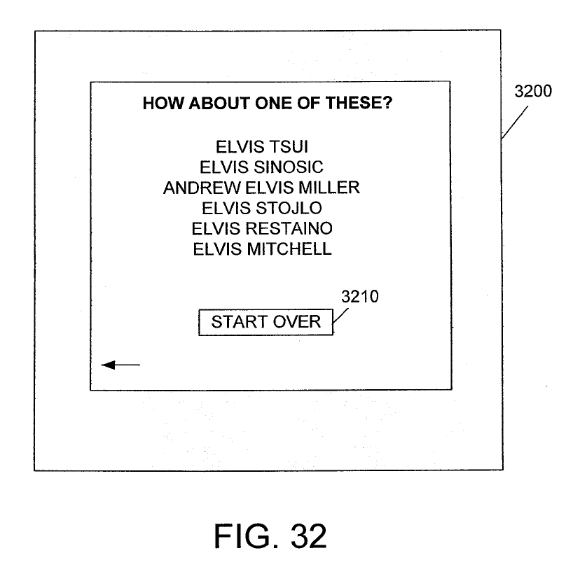

In the present example, Elvis Costello concerts are now listed. However, the user is not interested in Elvis Costello concerts either. So, the user may select the W button 3010 again. It is presumed for illustration purposes that there are no more possible search items that fit the concerts category 2940. As a result, in the present example, an interface 3200 is displayed listing all the other (or subset of other) items left in the search results that correspond to the character string “Elvis” as illustrated in FIG. 32. If none of these are desired by the user, the user can select a Start Over button 3210 to be presented a search interface screen, so that a new search may be initiated.

Advantageously, embodiments of the present disclosure address many of the shortcomings of user input devices when a lot of characters or letters are needed to be specified in an application interface, such as one offering search capabilities. By taking advantage of two-way communications capabilities of a computing device, an intelligent way to assist a user with inputting characters or letters is devised that provides personalization and a customizable viewing/browsing experience, in one embodiment. For example, embodiments of the context search system 100 may adaptively change a search interface based on selections made during a current search session. These selections may be weighed that more than selections made in past session in determining possible keyword matches.

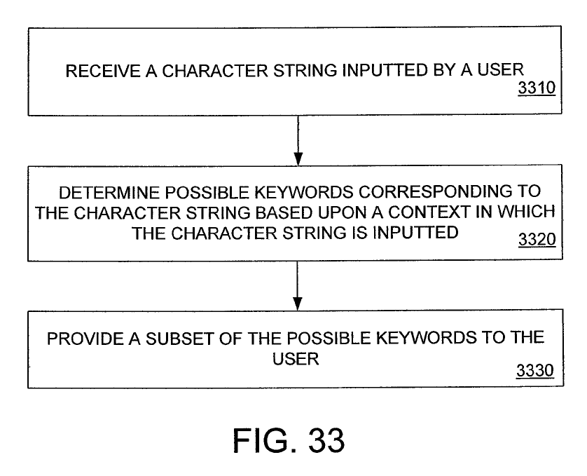

Referring now to FIG. 33, one embodiment of a method for inputting characters into a user interface is illustrated in the flow chart diagram of FIG. 33. As a first step, a character string inputted by a user is received (3310) (e.g., by network server 130). The character string may be, but is not limited to being, a portion of a search term or keyword that the user is intended to use as a subject of a search query. Possible keywords corresponding to the character string are determined (3320) based upon a context in which the character string is inputted. This context may be ascertained by analyzing a variety of sources of information (e.g., via database 135 by network server 130) including information known about the user and a current interface session (e.g., current session with a search engine). A subset of the possible keywords are provided (3330) to the user so that the user is allowed to select one of the keywords in the subset as a subject of a search query if the user finds a keyword to be of interest to the user. In addition, in one embodiment, in providing the subset of possible keywords, the keywords may be arranged so that the keyword that is deemed most likely to be of interest to the user is displayed first.

One should note that the above illustrations are directed to an interface to a search engine which is a non-limiting example. As one of ordinary skill on the art will understand, teachings of the present disclosure are not limited to search applications and may be utilized in a variety of interface applications.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure.

Therefore, having thus described the invention, at least the following is claimed:

1. A method for inputting characters into a user interface, comprising:
receiving a character string;
determining possible keywords corresponding to the character string based upon context in which the character string is input; and
providing at least a subset of the possible keywords to allow selection of at least one of the keywords in the at least a subset if a keyword of interest is found.

2. The method of claim 1, wherein providing the at least a subset of possible keywords comprises arranging keywords in the at least a subset so that the keyword that is deemed most likely to be of interest is displayed first.

3. The method of claim 1, further comprising:
determining the context in which the character string is input by analyzing information known about an identified user inputting the character string.

4. The method of claim 3, further comprising:
determining the context in which the character string is input by analyzing a current chronological state in which the character string is received.

5. The method of claim 1, further comprising:
providing results of a search performed on the selected keyword of interest, wherein the results are sorted in order in which at least a portion of the results is deemed to be of interest to a user.

6. The method of claim 1, further comprising:
enabling a user to indicate that a first subset of the possible keywords is not desired by the user; and
providing a second subset of the keywords using a different criteria for choosing the second subset than was used to choose the first subset, wherein both subsets are chosen using context information regarding a current search session.

7. The method of claim 1, wherein the possible keywords are organized in categories that are deemed to be of interest to a user based upon information known about the user.

8. The method of claim 1, wherein the possible keywords are organized in categories that are deemed to be of interest to a user based upon information known about the user and previous selections made by the user during a current search session.

9. A computer readable medium having a program for inputting characters into a user interface, the program having instructions for performing:
receiving a character string;
determining possible keywords corresponding to the character string based upon context in which the character string is input; and
providing at least a subset of the possible keywords to allow selection of at least one of the keywords in the at least a subset if a keyword to be of interest is found.

10. The computer readable medium of claim 9, wherein providing the at least a subset of possible keywords comprises arranging keywords in the at least a subset so that the keyword that is deemed most likely to be of interest is displayed first.

11. The computer readable medium of claim 9, the program further performing:
determining the context in which the character string is input by analyzing information known about an identified user inputting the character string.

12. The computer readable medium of claim 11, the program further performing:
determining the context in which the character string is input by analyzing a current chronological state in which the character string is received.

13. The computer readable medium of claim 9, the program further performing:
providing results of a search performed on the selected keyword of, wherein the results are sorted in order in which each is deemed to be of interest to a user.

14. The computer readable medium of claim 9, the program further performing:
enabling a user to indicate that a first subset of the possible keywords is not desired by the user; and
providing a second subset of the keywords using a different criteria for choosing the second subset than was used to choose the first subset, wherein both subsets are chosen using context information regarding a current search session.

15. The computer readable medium of claim 9, wherein the possible keywords are organized in categories that are deemed to be of interest to a user based upon information known about the user.

16. The computer readable medium of claim 9, wherein the possible keywords are organized in categories that are deemed to be of interest to the user based upon information known about a user and previous selections made by the user during a current search session.

17. A system for inputting characters into a user interface comprising:
a network server configured to receive a character string and determine possible keywords corresponding to the character string based upon context in which the character string is input;
at least one database of context information, the context information used by the network server to determine the context; and
a network client configured to receive the context information and the possible keywords; determine a subset of the possible keywords that are likely to be of interest after analyzing the context information; and display the subset of keywords.

18. The system of claim 17, wherein the network server determines the context in which the character string is input by analyzing information known about an identified user inputting the character string and the current chronological state in which the character string is received.

19. The system of claim 17, the network client further configured to receive an indication that a first subset of the possible keywords is not desired by a user, and in response, the network client provides a second subset of the keywords using a different criteria for choosing the second subset than was used to choose the first subset, wherein both subsets are chosen using context information regarding a current search session.

20. The system of claim 19, the network client further configured to organize the possible keywords in categories that are deemed to be of interest to a user based upon information known about the user and previous selections made by the user during a current search session.
